(19) United States
(12) Patent Application Publication
(10) Pub. No.: US 2018/0334031 A1
(43) Pub. Date: Nov. 22, 2018

(54) IGNITION INTERLOCK DEVICE

(71) Applicant: Julia Matthews, Kitchener (CA)

(72) Inventor: Julia Matthews, Kitchener (CA)

(21) Appl. No.: 15/842,656

(22) Filed: Dec. 14, 2017

Related U.S. Application Data
(60) Provisional application No. 62/434,183, filed on Dec. 14, 2016.
(60) Provisional application No. 62/457,215, filed on Feb. 10, 2017.

(51) Int. Cl. B60K 28/00; H04W 4/029; H04W 4/12

(52) U.S. Cl. CPC B60K 28/00; B60K 28/063; H04W 4/12; H04W 4/029

(57) ABSTRACT

A device is provided that when in use, is coupled to a vehicle, and restrains the vehicle against operation unless it detects a Bluetooth or WiFi enabled phone. A computing facility can be utilized which sends a signal to a user if a tracking feature is disabled on the phone. A computing facility can also be utilized which sends a signal to the user if the device is uncoupled from the vehicle. The device can be adapted to be coupled to the vehicle through an OBD-II port, and to restrain the operation of the vehicle through control signals sent, for example, to disable the fuel pump, engine starter or an ignition circuit.

### FIELD OF THE INVENTION

The invention relates to the field of child safety.

### BACKGROUND OF THE INVENTION

It is known for parents to track the location of their children using portable GPS devices or cellular phones.

It is known for vehicles to be provided with ignition interlock devices, which restrain the vehicle against operation unless a breath sample is provided which contains alcohol below a predetermined limit.

### SUMMARY OF THE INVENTION

The invention comprises a device which, in use, is coupled to a vehicle, and restrains the vehicle against operation unless it detects a Bluetooth or WiFi enabled phone. The invention can further comprise a computing facility which sends a signal to a user if a tracking feature is disabled on the phone. The device can further comprise a computing facility which sends a signal to the user if the device is uncoupled from the vehicle. The device can be adapted to be coupled to the vehicle through the OBD-II port, and to restrain the operation of the vehicle through control signals sent, for example, to disable the fuel pump, engine starter or an ignition circuit.

Persons of ordinary skill will readily appreciate the advantages associated with the invention.

A parent that wishes to safeguard a child, while at the same time permitting the child to operate a vehicle, can install the device in the vehicle and pair to the device, in a conventional fashion, the phones of the drivers permitted to use the vehicle [including the phone of the parent(s)].

Thereafter, so long as the device is coupled to the vehicle, it will only permit the vehicle to be operated in the presence of one of the paired phones.

The parent can similarly cause the phone of a permitted child user of the vehicle to be monitored to be trackable in a conventional way, i.e. using an app such as that sold by Not Your Child Inc. or the app distributed by Apple Inc. under the trademark Find my iPhone. The tracking program can be set up to send a notification to the parent if the tracking facility in the phone is disabled.

In use, if the tracking facility of the phone of the child is disabled, a message is sent to the parent, letting the parent know the last known location of the child—to permit search-and-rescue activities to be undertaken. Similarly, if the device is decoupled from the vehicle, a message is sent to the parent via a cellular network—to permit search-and-rescue activities to be undertaken.

Variations are possible.

One such variation involves an adaptation of a conventional breath alcohol ignition interlock device.

By way of background, in many jurisdictions, a person that is convicted of impaired driving is required to install a breath alcohol ignition interlock device in his or her vehicle for a period of time.

known form of breath alcohol ignition interlock device involves a module that is spliced into the ignition circuitry of the vehicle and a handheld breath alcohol tester that communicates wirelessly with the module. The module includes a relay that only allows the vehicle to be started following delivery of a breath sample to the handheld device that contains alcohol below a predetermined limit.

It is commonplace for the offender to pay an installation fee when the device is installed in the vehicle, monthly payments during the period and a removal fee when the device is removed.

The contemplated adaption involves firmware in the module that allows the module to speak with a cellular phone after the period, to function as the above-described inventive device. This adaptation has the advantage of reducing costs to an offender that wishes to have the inventive device installed in his or her vehicle following the period; the user can avoid the cost of the removal of the module. In this case, the module could be purchased or rented.

Yet further advantages associated with this latter method involve the availability of the module for subsequent use. For example, if a module is installed in the vehicle of a parent and operated according to the invention while the children of the parent were relatively young, i.e. below the legal drinking the age, the parent could elect, when the children attained the drinking age, to voluntarily purchase a wireless breath alcohol tester, and reconfigure the module to require clean breath alcohol tests prior to operation of the vehicle. As well, the module could be modified to selectively require breath alcohol testing based upon the phones in the vicinity. As yet a further modification, a web based platform could be provided, to allow the parent to selective engage/disengage the breath test requirement as needed.

1. Apparatus for use with a vehicle and a cellular device, the apparatus comprising:
a device which
is adapted to wirelessly communicate directly with the cellular device in use, is electrically coupled to the vehicle; and
in use, is adapted to permit the vehicle to be operated only when wirelessly communicating directly with the cellular device.

2. A system for use with a vehicle and a cellular device, the cellular device being of the type which has a functionality which, when enabled, allows a supervisor to monitor the location of the device, the system comprising:
computer executable instructions that when executed by the cellular device send a message to the supervisor when the functionality is disabled; and
a device which
is adapted to wirelessly communicate directly with the cellular device in use, is electrically coupled to the vehicle; and
in use, is adapted to permit the vehicle to be operated only when wirelessly communicating directly with the cellular device.
